(19) United States
(12) Patent Application Publication
(10) Pub. No.: US 2016/0140774 A1
(43) Pub. Date: May 19, 2016

(54) METHOD AND SYSTEM FOR WIRELESS PAYMENT FOR PARKING

(71) Applicant: MASTERCARD INTERNATIONAL INCORPORATED, Purchase, NY (US)

(72) Inventors: Henry Weinberger, New York, NY (US); Randall K. Shuken, Westport, CT (US)

(21) Appl. No.: 14/542,964

(22) Filed: Nov. 17, 2014

(51) Int. Cl. G07B 15/02; G06Q 20/32

(52) U.S. Cl. CPC G07B 15/02; G06Q 20/322

(57) ABSTRACT

A method and a system are provided for wireless payment of parking fees or other charges for a vehicle. The method includes determining the location of the vehicle with a wireless communication device having a parking software application (App). The location is determined using a global positioning system. The method further includes transmitting the street parking location, a vehicle identification or user identification, and a payment to a parking authority server for initiating a street parking session with the wireless communication device, and allowing a user to change the street parking location with the wireless communication device. The method of this disclosure allows a user to change the street parking location, in particular, the user can select one or more street parking locations and initiate one or more street parking sessions with the wireless communication device.

### BACKGROUND OF THE DISCLOSURE

1. Field of the Disclosure

The present disclosure relates to a method and a system for wireless payment of parking fees or other charges for a vehicle.

2. Description of the Related Art

Any parking system consists of the following main features: (a) authorization which includes seeking permission to park by the user and by a parking authority to grant authorization; (b) payment that includes collecting payment from the user; (c) validation which includes checking whether the authorized time has run out or the vehicle was never authorized; and (d) enforcement that includes a method used by the parking authority for penalizing vehicles that have not paid or have overstayed their authorized time.

These requirements are fundamental for parking systems. They are present in legacy systems and continue to be requirements for new systems. Modern systems and methods are using wireless technologies to improve consumer experience and reduce the cost of providing service while still meeting the above requirements.

In the past several years, a number of wireless payment systems have been introduced to replace the coin operated meter and the payment kiosks. In most cases, a cell phone is involved and the systems are generally referred to as, “pay by cell”. This has been facilitated by the fact that modern cell phones can engage in payment transactions with a remote server either via commonly available cellular data services or through automated voice activated systems. The Verrus system is an example of prior art use of wireless means for parking authorization and payment.

In the Verrus system, the user's credentials, such as mobile phone number, vehicle license plate number, credit card number and other information are required to be pre-registered with Verrus. Once registered, the user can park his vehicle in parking lots with which Venus has established a business arrangement to allow its method of remote payment. The following are prominently displayed in the lot: (a) the fact that this is a Verrus authorized parking lot, and (b) a parking lot ID number. The user sends an SMS or makes a phone call to communicate the parking lot ID and her requested parking duration. Parking authority agents can verify the authorization status of parked vehicles by accessing the Verrus server, which is remotely accessible to the agents.

Other similar systems have also been deployed in many major cities. For example, a cashless parking system has been developed by Parkmobile and deployed in Washington, D.C. and several states in the United States. As in the Verrus system, the user has a prearranged payment agreement with Parkmobile, which is the parking service provider. In order to initiate a parking session, the user has to communicate a parking zone ID to a Parkmobile server via his mobile phone. This communication can occur by calling a phone number or entering data on the user's mobile phone as part of executing a downloaded mobile application. The method of enforcement is based on a parking authority agent determining the compliance status of each individual vehicle (with respect to the duration of stay and the paid parking fee) using a handheld checking terminal device to access the Parkmobile server.

Although remote wireless payment systems and methods in support of parking applications exist in the prior art, these systems currently offer suboptimal user experiences. There is a need for a system and a method that allows for updating parking time without geographic limitations. There is also a need for a system and a method that allows for parking in more than just one specific spot such as any available parking spaces in midtown Manhattan. There is further a need for a system and a method that allows for use by multiple users that does not force one (1) car to be registered with only one (1) user. There is yet further a need for a system and a method that allows for use by multiple cars so that, for example, a family with three (3) cars will not be required to register each car.

### SUMMARY OF THE DISCLOSURE

The present disclosure relates to a method and a system for wireless payment of parking fees or other charges for a vehicle. The method and system allow a user to change street parking location, in particular, the user can select one or more street parking locations and initiate one or more street parking sessions with a wireless communication device.

The present disclosure provides a method that involves determining the location of the vehicle with a wireless communication device having a parking software application (App). The location is determined using a global positioning system. The method also involves transmitting the street parking location, a vehicle identification or user identification, and a payment to a parking authority server for initiating a street parking session with the wireless communication device, and allowing a user to change the street parking location with the wireless communication device.

Allowing a user to change the street parking location involves the user selecting another street parking location and initiating another street parking session with the wireless communication device. The street parking includes parking in any open area where there is no access barrier to available parking spots and, in particular, includes actual street parking and parking in open lots with no access control (e.g., municipal parking in cities and towns (e.g., New York City, San Francisco and the like) including street parking, open lot parking and municipal parking garages). The wireless communication device includes any wireless device carried by a user and used to access the internet, or any wireless device installed in, and made a part of, the electronic system of a vehicle and used to access the internet.

The present disclosure also provides a method that involves providing a wireless communication device having a parking software application (App), and determining the location of the vehicle with the wireless communication device. The location is determined using a global positioning system. The method also involves accessing rules and payment information for street parking of the vehicle at the location with the wireless communication device and the global positioning system; wirelessly transmitting the street parking location, a vehicle identification or user identification, and a payment to a parking authority server for initiating a street parking session with the wireless communication device; receiving confirmation of payment from the parking authority server with the wireless communication device; and allowing a user to change the street parking location with the wireless communication device.

The present disclosure further provides a system that includes a wireless communication device having a parking software application (App). The wireless communication device provides user input and output and position location capability. The system also includes a parking authority server connected to the wireless communication device. Both the wireless communication device and the parking authority server are configured to pay for street parking according to a method that involves determining the location of a vehicle with a wireless communication device having a parking software application (App). The location is determined using a global positioning system. The method further involves transmitting the street parking location, a vehicle identification or user identification, and a payment to a parking authority server for initiating a street parking session with the wireless communication device, and allowing a user to change the street parking location with the wireless communication device.

The present disclosure yet further provides a system that includes a wireless communication device having a parking software application (App). The wireless communication device provides user input and output and position location capability. The system also includes a parking authority server connected to the wireless communication device. Both the wireless communication device and the parking authority server are configured to pay for street parking according to a method that involves providing a wireless communication device having a parking software application (App), and determining the location of a vehicle with the wireless communication device. The location is determined using a global positioning system. The method further includes accessing rules and payment information for street parking of the vehicle at the location with the wireless communication device and the global positioning system; wirelessly transmitting the street parking location, a vehicle identification or user identification, and a payment to a parking authority server for initiating a street parking session with the wireless communication device; receiving confirmation of payment from the parking authority server with the wireless communication device; and allowing a user to change the street parking location with the wireless communication device.

The present disclosure also provides a system that includes a wireless communication device that includes a user input and output and position location capability, and a server connected to the wireless communications device. Both the wireless communications device and the server are configured to pay for parking according to the methods described herein.

The present disclosure further provides a system that includes a vehicle electronic system that includes a user input and output, a wireless communications device and position location capable of combining satellite navigation and inertial navigation; and a server connected to the wireless communications device. Both the vehicle electronic system and the server are configured to pay for parking according to the methods described herein.

### BRIEF DESCRIPTION OF THE DRAWINGS

FIGS. 1A-1F show exemplary wireless communication device screens for a use case corresponding to initiation of parking, referred to as “Start Parking,” in open streets associated with an embodiment of this disclosure.

FIG. 2 shows a process flow diagram corresponding to the use case of FIGS. 1A-1F.

FIGS. 3A-3D show exemplary wireless communication device screens for a use case corresponding to the termination of parking, referred to as “End Parking,” in open streets.

FIG. 4 shows a process flow diagram corresponding to the use case of FIGS. 3A-3D.

FIGS. 5A-5D show examples of a vehicular display screen for Start Parking in open streets when the wireless communication device is integrated into the vehicle's electronic system.

FIGS. 6A-6C show examples of a vehicular display screen for End Parking in open streets when the wireless communication device is integrated into the vehicle's electronic system.

FIG. 7 is a block diagram illustrating a method for wireless payment of parking fees for a vehicle in accordance with exemplary embodiments of this disclosure.

FIG. 8 is a block diagram illustrating a method for wireless payment of parking fees for a vehicle in accordance with exemplary embodiments of this disclosure.

A component or a feature that is common to more than one drawing is indicated with the same reference number in each drawing.

### DESCRIPTION OF THE EMBODIMENTS

Embodiments of the present disclosure are described more fully hereinafter with reference to the accompanying drawings, in which some, but not all, embodiments of the disclosure are shown. Indeed, this disclosure can be embodied in many different forms and should not be construed as limited to the embodiments set forth herein. Rather, these embodiments are provided so that this disclosure clearly satisfies applicable legal requirements. Like numbers refer to like elements throughout.

As used herein, entities can include one or more persons, organizations, businesses, institutions and/or other entities, such as financial institutions, services providers, and the like that implement one or more portions of one or more of the embodiments described and/or contemplated herein. In particular, entities can include a person, business, school, club, fraternity or sorority, an organization having members in a particular trade or profession, sales representative for particular products, charity, not-for-profit organization, labor union, local government, government agency, or political party.

As used herein, “App” refers to application software.

As used herein, “wireless communication device” refers to any wireless device, such as cellular phone, smart phone, or personal data device, carried by a user and used to connect to the Internet.

As used herein, “parking application server” refers to a server operated by the parking service provider that is connected to the internet and running parking applications (e.g., starting parking and ending parking).

As used herein, “parking authority” refers to an entity that owns or controls parking facilities and collects fees for their use. Examples are municipal parking authorities such as cities and towns (e.g., New York City, San Francisco and the like) for street parking and municipal parking garages.

As used herein, “user platform” refers to an electronic system including, for example, positioning location subsystems, where the electronic system supports a parking payment application. Examples are a wireless communication device and an electronic system of a vehicle.

As used herein, “parking service provider” refers to a service provider providing parking payment and other value added services.

As used herein, “payment service provider” refers to an entity providing payment services to the parking authority. Examples are MasterCard®, PayPal®, banks, and the like.

As used herein, “payment server” refers to computing infrastructure of the payment service provider.

As used herein, “street parking” refers to parking in any open area, where there is no access barrier to the available parking spots. This category includes both actual street parking and parking in open lots with no access control.

As used herein, “parking authority checker” refers to an agent of a parking authority who is responsible for validating the status (paid/unpaid, expired/unexpired) of a parking session for a given vehicle.

As used herein, “parking authority checking terminal” refers to a handheld terminal used by the parking authority checker to perform validation of parking sessions, or targeted enforcement, of parked vehicles.

As used herein, <.>—delimiting symbols used to refer to an icon shown on a display screen, such as <Start Parking>.

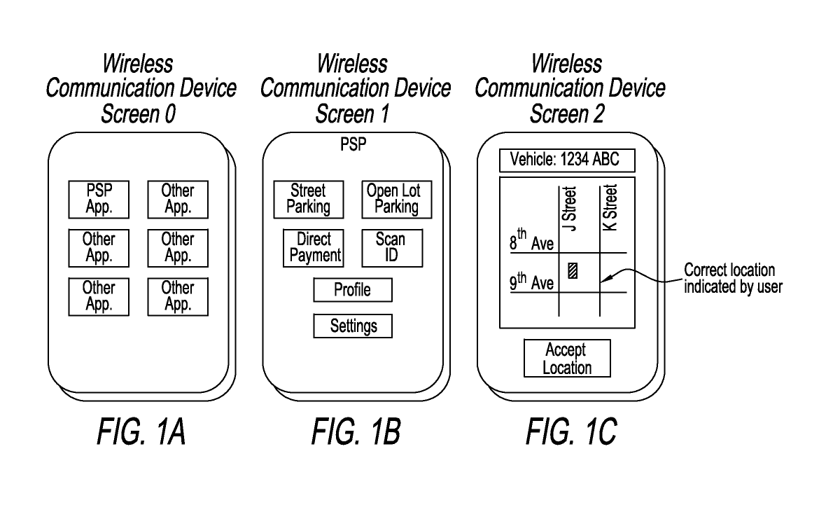

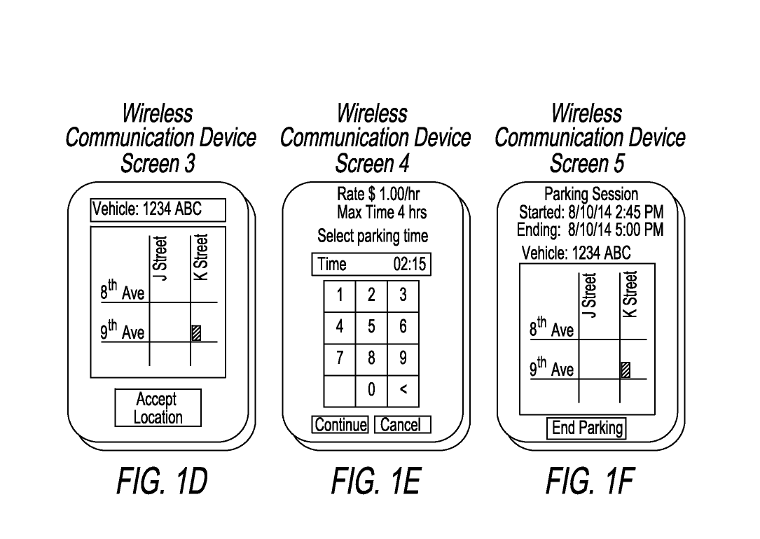

FIGS. 1A-1F show a set of screen designs associated with an embodiment of this disclosure. The screens designs are for a wireless communication device but can be adapted to a vehicular display, where the vehicle's electronic system has similar functions, or subsystems, as a wireless communication device, including some or all of the following: a positioning subsystem consisting of a satellite navigation system such as GPS, a cellular data modem, a short range wireless technology such as Bluetooth and/or near field communications, or NFC. A vehicular electronic system can have additional functions not present in a wireless communication device, such as a motion sensing inertial navigation system that helps to improve the position accuracy beyond that achievable by a satellite navigation system alone. The vehicular electronic system can also have an integrated RFID modem.

The usage scenario, or use case, illustrated in FIGS. 1A-1F involves a user parking in an open street and launching a parking App to start a parking session. In modern wireless communication devices, a common way to launch an App is to touch an icon on a touch sensitive display screen. An exemplary list of App icons is shown in FIG. 1A wireless communication device Screen 0, including one for parking, “Parking Service Provider (PSP) App”.

When the user selects, or touches, the parking service provider App icon in wireless communication device Screen 0 (FIG. 1A), which is shown as a root screen from which all Apps are launched, the browser opens a subsequent page, where a number of parking options are displayed. As illustrated in FIG. 1B, wireless communication device Screen 1, can be thought of as a root screen for parking Apps as well as the starting screen for a number of administrative options, such as Profile and Settings. It should be noted that the screen sequences described here are only examples of user interfaces for parking applications and that other designs are possible within the scope of this disclosure.

For the present scenario, street parking, the user selects <Street Parking> on Screen 1, which leads (by browser action) to wireless communication device Screen 2 (FIG. 1C). Here, the following can be displayed: (i) the vehicle's license plate (e.g., 1234 ABC), which can be sensed automatically as described herein; (ii) the location of the user as indicated by the wireless communication device's position location subsystem; (iii) option for the user to either accept the indicated location by selecting <Accept Location> or correct the indicated position by selecting a different position on the display screen than the one indicated.

The position indicated by a wireless communication device's position location subsystem is expected to be sufficiently accurate for parking operations in most environments. In such environments, with GPS unassisted by inertial navigation but assisted by other technologies such as knowledge of cellular base stations and Wi-Fi access points, an accuracy of 5-10 m can be achieved. However, in dense urban canyons, owing to blockage of satellite signals and multipath propagation, the accuracy can be degraded beyond that acceptable for parking applications, such as introducing an ambiguity/error regarding the street the vehicle is on. An example of such an ambiguous indication is shown in FIG. 1C wireless communication device Screen 2. When the wireless communication device is integrated into a vehicular electronic system, assistance to the GPS subsystem can be available from an inertial navigation system, which can increase the position accuracy to a level sufficient to enable parking in deep urban canyons without user corrections of the indicated position.

The selection of an alternate position can be performed in a variety of ways, including but not limited to, touching a selected location on a touch sensitive screen or moving a cursor to the selected location and pushing a button. In order to aid the user in gaining awareness of his whereabouts, the displayed map can indicate major landmarks, such as well-known buildings and bridges, as well as street names.

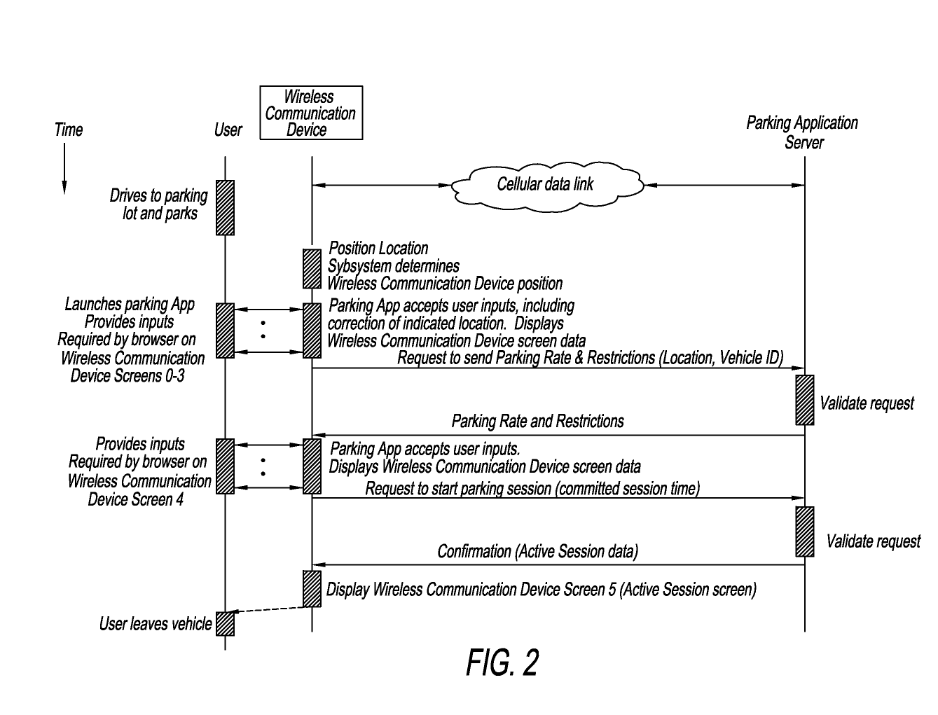

The selection of <Accept Location> by the user on FIG. 1D wireless communication device Screen 3 sends a message over a cellular data link to the parking application server indicating that a wireless communication device of specified ID and location, wishes to initiate a street parking session. The server authenticates the user and sends information back to the wireless communication device about the current parking rates and restrictions at the stated location. This information is displayed as in FIG. 1E wireless communication device Screen 4 and the transactions corresponding to the above steps are illustrated in FIG. 2.

In a variation of the embodiment described above, information about the parking rates and restrictions can be stored in the wireless communication device. This avoids the exchange of a cellular data link message between the wireless communication device and the parking application server corresponding to the request and downloading of the parking rates and restriction information, and thereby reduces the process latency but may increase the storage requirement on the wireless communication device. The choice of a particular embodiment is a matter of design choice.

Wireless communication device Screen 4 allows the user to cancel the transaction if, for example, the rates and restrictions are deemed unacceptable. This feature can increase in importance in the future as the present trend is for parking authorities to move to dynamic rates that change with parking spot occupancy levels. The user can choose not to park at the present location after reviewing the rates and restrictions.

In the present example, wireless communication device Screen 4 (FIG. 1E) is shown as requiring the user to enter a committed parking session time. Whether the parking session time has to be pre-committed depends on the policy of the parking authority. In some municipalities, such as Washington D.C., it is required whereas in others it is not. In some areas, where the policy allows payment for the actual session time, user input of parking time may be redundant and deleted from the steps. The decision to skip the user input step can be based on the location sensed by the position location subsystem and knowledge of local parking policies stored in either the parking application server (and downloaded to the wireless communication device) or the App in the wireless communication device.

The user's commitment to park at the selected spot occurs when he selects <Continue> on wireless communication device Screen 4 (FIG. 1E). This leads to a request/confirm, cellular data transaction with the parking application server, responsive to which FIG. 1F wireless communication device Screen 5 is displayed, which is the last screen of this embodiment of the start parking process. The screen shows the session start time, the scheduled end time (for pre-committed session times), the vehicle ID (license plate number), and the vehicle's location (which can provide an additional user benefit in helping him to locate the vehicle on his return). This screen can also be regarded as a session status screen, which the user can view remotely on his wireless communication device at all times until the session has ended.

FIG. 2 is a process flow that shows a transaction ladder diagram corresponding to the above described steps. The diagram shows the sequence of steps in the time domain, including the points at which cellular data link transactions occur with the parking application server. Both in this example as well as all others in this disclosure, a dotted line is used to indicate a causal connection between two actions; i.e., the action at the start of the arrow leads to the action to which the arrow is pointing. It will be noted that the latency of the entire process is typically determined largely by the two cellular data link transactions for communication with the parking application server; the other steps local to the wireless communication device, that this, they are taken by the browser in response to user inputs and without any external communications. In cases where the parking rate information is not subject to dynamic changes and is advertised to the user through legacy methods, or is otherwise known to the user, or the information is stored in the wireless communication device as suggested above as an alternative embodiment, the action of requesting and downloading the parking rate/restriction information can be deleted to shorten the overall latency of the process.

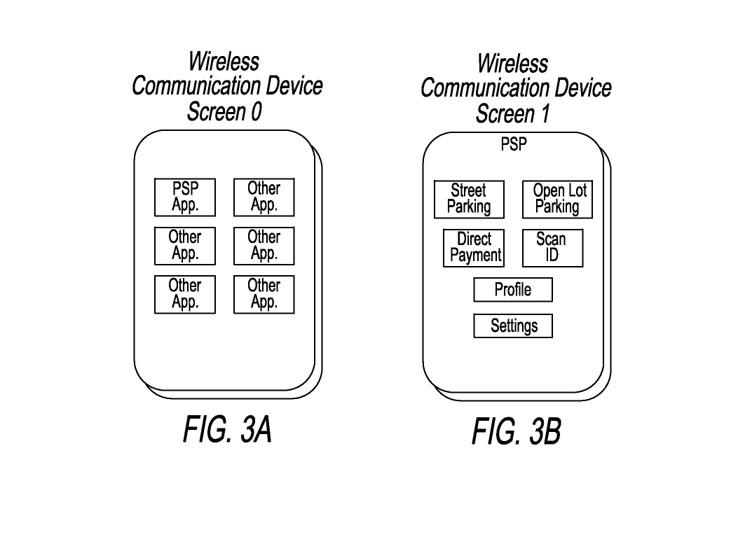

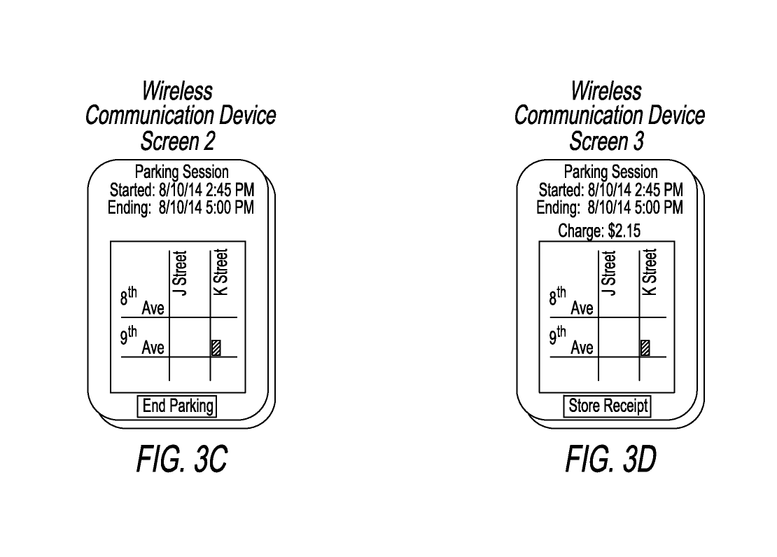

Referring to FIGS. 3A-3D, as for the start parking use case described above, wireless communication device Screen 0 (FIG. 3A) is the root screen from which all Apps in this embodiment are launched. Selecting <Parking Service Provider App>, the parking App icon, leads to wireless communication device Screen 1 (FIG. 3B), where the user selects <Street Parking>. As a session is currently active, this leads, in FIG. 3C wireless communication device Screen 2, to the session status screen, where the session is shown as active (the ending time occurs in the future). It is noteworthy that this behavior is different when <Start Parking> is selected with an inactive street parking session, the behavior in that case being shown by wireless communication device Screen 2 in FIG. 1C.

As the use case described above for start parking was one of committed parking time, contrasted with indefinite parking time, the session end time is predetermined. The screen provides an <End Parking> option. If the use case corresponds to indefinite parking time, the user selects the <End Parking> button to terminate the session.

Selecting <End Parking> on wireless communication device Screen 2 leads to the terminal screen, FIG. 3D wireless communication device Screen 3. The session details and charged amount are shown on this screen. An option for storing this screen as a digital receipt is provided through <Store Receipt>.

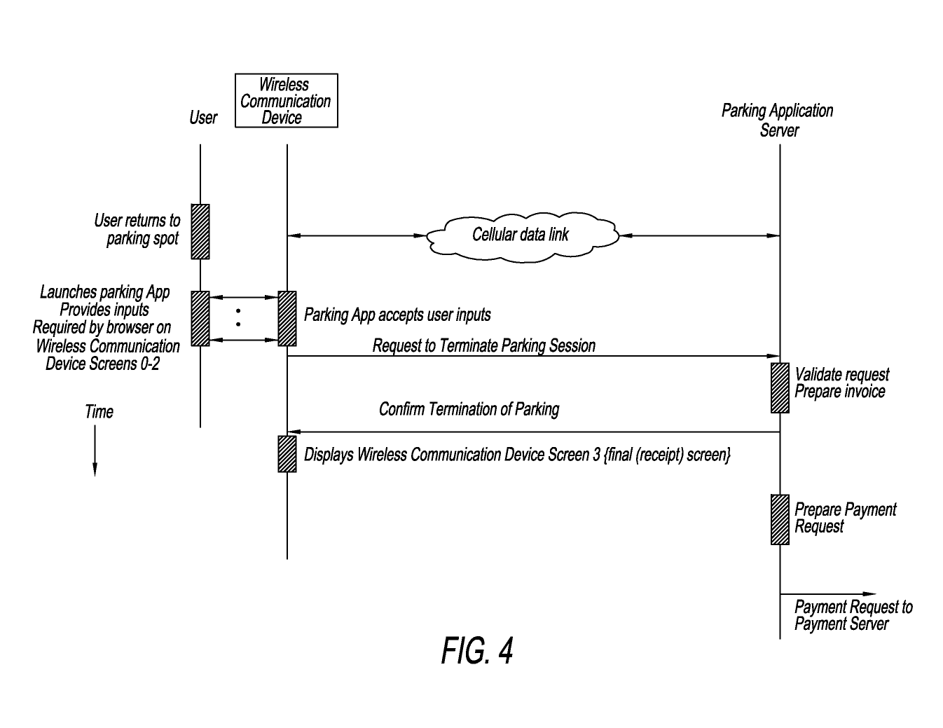

The transaction ladder diagram for end parking in the street parking case is shown in FIG. 4. As in FIG. 2, the diagram shows the sequence of steps in the time domain, including the point at which a cellular data link transaction occurs with the parking application server.

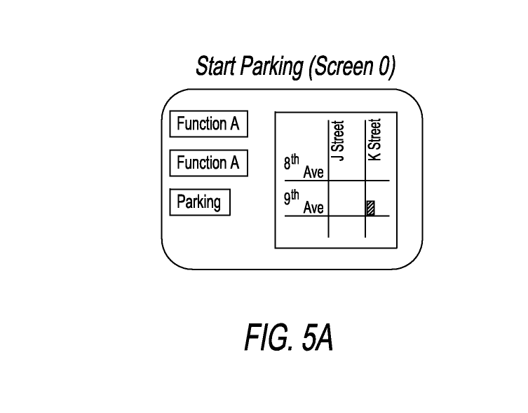

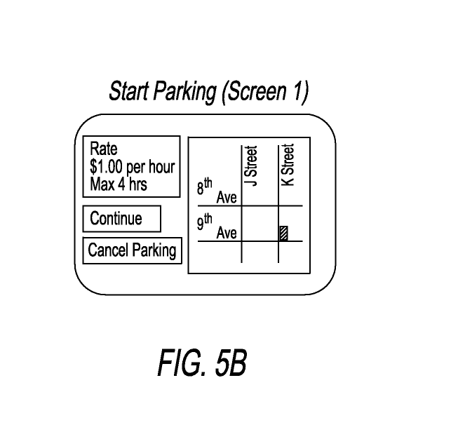

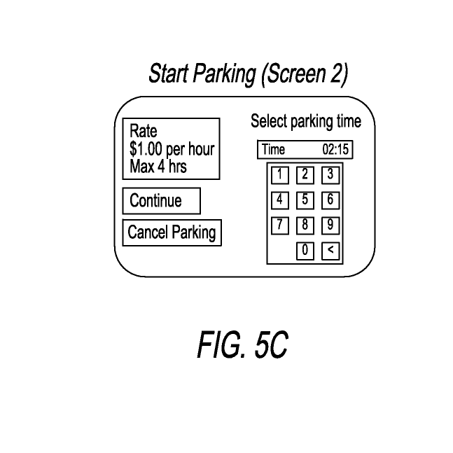

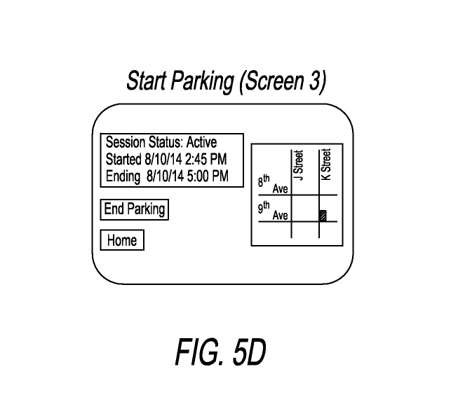

FIGS. 5A-5D shows how a street parking (Start Parking) App can be supported on a vehicular electronic system, based on adaptations of the wireless communication device screens. On the root screen, FIG. 5A Vehicle Display Screen 0, the user launches the parking App by selecting <Parking>. This sends a message to the parking application server via a cellular data link. The message includes the vehicle's ID and its position, indicated by its position location subsystem. As in the wireless communication device case, it is possible to add another screen to allow the user to correct the indicated position, and such embodiments are covered by the methods/systems taught in this disclosure, although not shown in FIGS. 5A-5D. However, such correction is less likely to be necessary when the user platform is integrated into the vehicle's electronic system, as positioning assistance can be available from the vehicle's inertial navigation system which can obviate the necessity for correction.

The parking application server responds with the parking rate and restrictions information, which are displayed in FIG. 5B Vehicle Display Screen 1. If the rate/restrictions are acceptable, the user selects <Continue>; if not, he selects <Cancel Parking>. Assuming that he selects the former, the next screen, FIG. 5C Vehicle Display Screen 2, requests the user to enter a committed parking session time, assuming that such commitment is required by the parking policy. The browser can be programmed to skip this step based on the vehicle's location and knowledge of the policy of the local parking authority.

Following the entering of committed parking session time in FIG. 5C Vehicle Display Screen 2, the user selects <Start Parking>. This sends a message to the parking application server, which causes a parking session to be started at the server and a confirmatory session status screen is returned to the user platform, which is displayed as FIG. 5 D Vehicle Display Screen 3. The user can exit the parking App and return to the root screen, Screen 0 (FIG. 5A), by selecting <Home> on this screen.

If Screen 2 (FIG. 5C) were deleted based on knowledge of the local parking authority's policy and no user correction of the indicated position were required, the number of user steps required to complete the Start Parking process would be reduced to two, comprising those in Screens 0 and 1 (FIGS. 5A, 5B). If the rate/restriction information were known through other means, the number of screens requiring user input could be reduced to one (Screen 0, FIG. 5A), leading to one-touch parking.

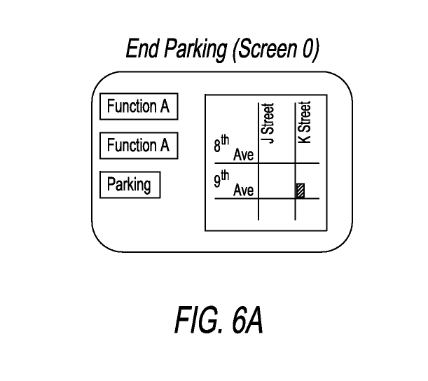

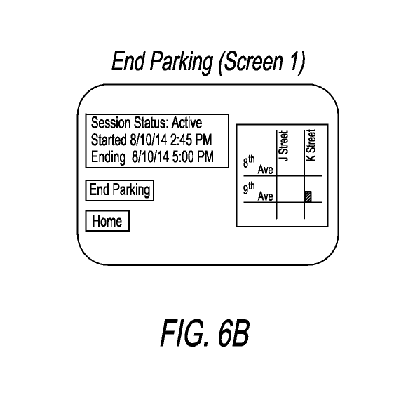

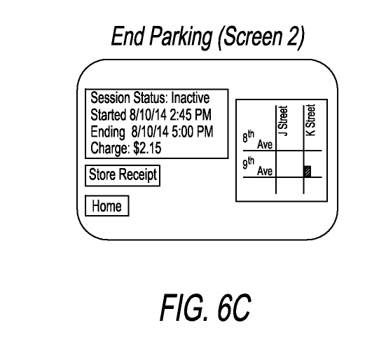

FIGS. 6A-6C show the street parking (End Parking) use case executed from the vehicular electronic system. The user selects <Parking> in the root screen, FIG. 6A Vehicle Display Screen 0. As the session is known to be active, the browser opens the session status screen, FIG. 6B Vehicle Display Screen 1. Here the user selects <End Parking>. This sends a message to the parking application server, which causes the session to be terminated at the server and a confirmatory receipt screen, containing the session start and end times and the amount charged, to be returned to the user platform. The user can store the receipt and/or return to the root screen by selecting <Store Receipt> and <Home> buttons, respectively, shown on the exemplary FIG. 6C Vehicle Display Screen 2.

In an embodiment, the method of this disclosure includes determining the location of the vehicle with a wireless communication device having a parking software application (App). A global positioning system is used for determining the location. The method further includes transmitting the street parking location, a vehicle identification or user identification, and a payment to a parking authority server for initiating a street parking session, with the wireless communication device, and allowing a user to change the street parking location with the wireless communication device.

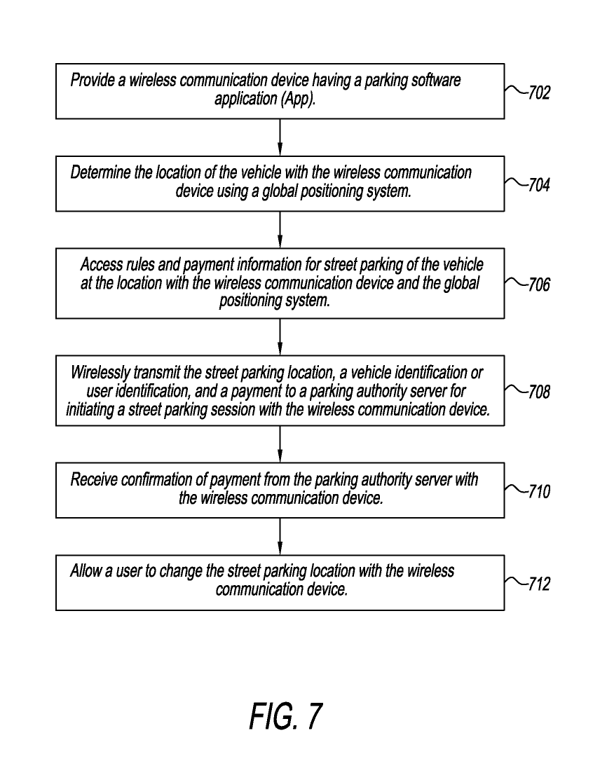

In another embodiment shown in FIG. 7, the method includes providing a wireless communication device at 702 having a parking software application (App), and determining the location of the vehicle with the wireless communication device at 704. A global positioning system is used for determining the location. The method further includes accessing rules and payment information for street parking of the vehicle at the location with the wireless communication device and the global positioning system at 706; wirelessly transmitting the street parking location, a vehicle identification or user identification, and a payment to a parking authority server for initiating a street parking session, with the wireless communication device at 708; receiving confirmation of payment from the parking authority server with the wireless communication device at 710; and allowing a user to change the street parking location with the wireless communication device at 712.

The method further includes receiving notification from the parking authority server of an end of the street parking session, and receiving notification from the parking authority server of at least one of street parking session status including street parking session start and end times and street parking session remaining time. The method also includes providing secure data links between the wireless communication device and the parking authority server.

A unique feature of the method of this disclosure is allowing a user to change the street parking location. After completing a parking session, the user can select another street parking location and initiate another street parking session with the wireless communication device.

In an embodiment, the global positioning system is capable of combining satellite navigation and inertial navigation. In another embodiment, the parking software application (App) is connected to the parking authority server, and both the parking software application (App) and the parking authority server are configured to pay for street parking.

As indicated herein, the present disclosure provides a method and a system for wireless payment of parking fees or other charges for a vehicle. The other charges can include any charges related to the vehicle or to the location of the vehicle.

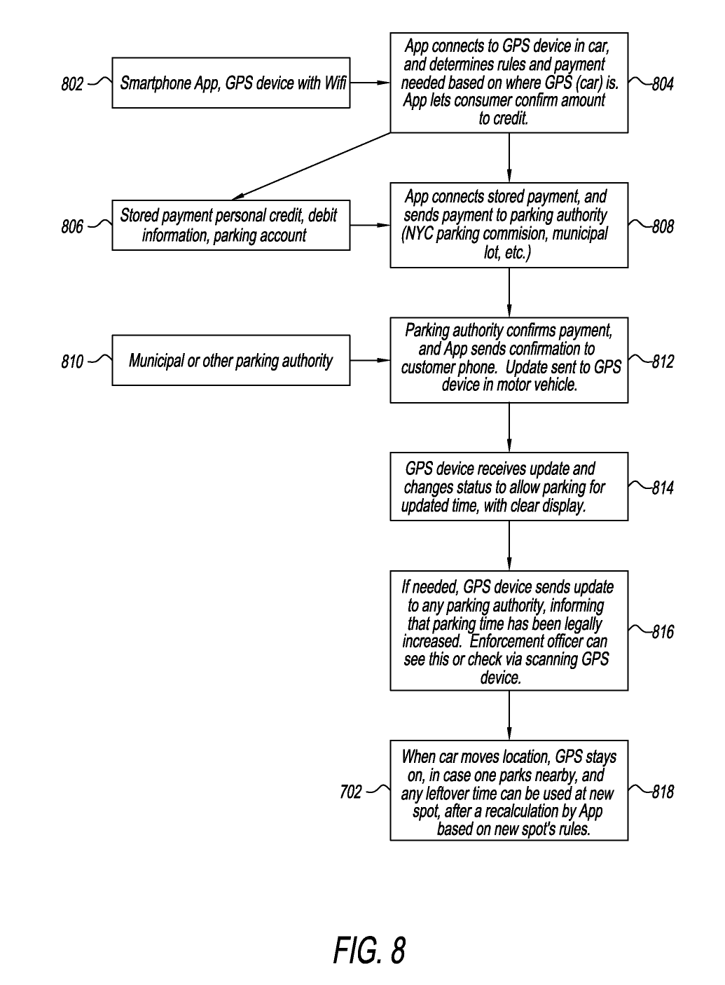

In a particular embodiment shown in FIG. 8, the method includes providing a smartphone App and GPS device with Wifi at 802. At 804, the parking App connects to the GPS device in the vehicle and determines parking rules and payment based on where the GPS (vehicle) is parked. The parking App lets the user confirm the amount to credit. A stored payment, personal credit, debit information and parking account are at 806. At 808, the parking App contacts stored payment and sends payment to the parking authority (e.g., NYC parking commission, municipal lot, etc.). The municipal or other parking authority is shown at 810. At 812, the parking authority confirms payment and the parking App sends confirmation to the used smartphone. An update is sent to the GPS device in the vehicle. At 814, the GPS device receives an update and changes the status to allow for parking for the updated time with a clear display. At 816, if needed, the GPS device send an update to any parking authority to inform them that the parking time has been legally increased. An enforcement officer can see this or check via scanning the GPS device. At 818, when the vehicle moves parking location, the GPS stays on in case the user parks nearby. Any leftover time can be used at the new parking location, after a recalculation by the parking App based on the parking rules for the new location.

In accordance with this disclosure, the parking App can provide comprehensive information about on and off street parking including: signs and city parking rules for all street locations; applicable parking regulations by city, street, time of day, day of week, and weather conditions (e.g. snow parking bans); current events that could disrupt parking such as construction, detours, street repairs, moving activities, demonstrations, holidays, parades, fairs, and other events; existence of meters, price per time for meters, parking rules such as residential, commercial; alerts about meter expiration, street sweeping, snow emergencies; the ability to locate a parked car; the ability to find an open spot.

In an embodiment, the method and system of this disclosure can be “pay as you go”. The method and system can be precise to a point that a user only pays for the parking time actually used. For example, if a user leaves a parking location 20 minutes earlier than expected, the user would not get charged the full amount, but only for the time that the user's vehicle was actually in the parking spot. The user could pay through a replenishment model or with pre-paid value.

In another embodiment, the method and system of this disclosure can be used to pay for parking at non-traditional parking areas such as a person's driveway or property. For example, the person can register the parking areas in their driveway or property with the parking App. The parking App allows a user to find and pay to park in the person's driveway or property. This embodiment can also be useful for commercial applications (e.g., office buildings, and the like) that have no business during weekends.

Another embodiment of this disclosure includes validation and enforcement of parking. The parking application server has knowledge of the locations of all parked vehicles with active (unexpired), expired and expected-expired sessions.

It is preferable for the parking application server to know when a parking session has ended. The termination time of the parking session determines the expired/unexpired status of the session, making the user potentially liable for fines if the session has expired. Furthermore, knowledge of the time-overage (the time by which the user has overstayed the parking session) can be used by a parking authority to graduate the fine (e.g., smaller fines for smaller overages). In some markets, by parking authority policy, the user is required to buy a predetermined amount of session time at the onset of the session. In such markets, some legacy systems, such as Parkmobile, provide no provision for the user to end an active parking session. In other markets, where the user only pays for the actual duration of the session, the user is allowed to end an active session (he is motivated to do so as he pays less if the session is terminated earlier). In the former case, the parking application server is unaware of the true status of vehicles showing expired session status in its database. The vehicles can still be at the parked location, having overstayed their purchased time, or they may have left.

As an illustrative example, a parking authority checker has decided on a particular area that he is going to survey for checking, or targeted enforcement. In one embodiment, the area can be selected unilaterally by the parking authority checker depending on his work plan, which may be influenced by considerations other than the highest density of vehicles with expired/expected-expired sessions subscribing to a particular parking service provider. In this embodiment, a parking authority checking terminal sends a message to the parking application server, using a cellular data link, requesting information about the parked locations, session status and attributes of subscribing vehicles in the specified targeted enforcement area. The request can also include the parking authority checker's present location. The parking authority checking terminal provides enabling means for the parking authority checker to select a target area and to send a message with the information described above.

In an alternative embodiment, the parking authority checker can request an advisement about the area to survey. This approach can be preferable when most parked vehicles are subscribers to the subject parking payment system, or it is advantageous to check such vehicles separately from other vehicles. In this case, the parking authority checker sends a message to the parking application server, using a cellular data link, requesting advisement on a target area; the request can include the parking authority checker's present location. Responsive to the above request, the parking application server downloads to the parking authority checking terminal, using a cellular data link, a recommended target area and the parked locations, session status and attributes of subscribing vehicle in the specified area. The area can include the parking authority checker's present location.

Responsive to the receipt of the request message from the parking authority checking terminal, following either of the above methods for selecting the target area, the parking application server downloads to the parking authority checking terminal the requested information using a cellular data link. The location of each vehicle subscribing to the subject parking payment service is shown as an icon, such as a dot, with a distinguishing feature such as color or shape to indicate its session status. Icons of different colors/shapes can be used to further distinguish vehicles with unexpired sessions from vehicles with either expired or expected-expired sessions. Detailed attributes of vehicles represented by each icon can be blown up and displayed by selecting an icon and requesting more information thereof.

An example of key information is the vehicle license plate number and session information, such as status (unexpired, expired and expected-expired), start time, end time and overage relative to present time. This information can be supplemented by an image of the vehicle, if available and the approximate street location.

The method/system described above of identifying a target area for enforcement, wirelessly downloading information about the identities and parking session status of vehicles parked in the target area, and displaying the information on a parking authority checking terminal in a way so as to facilitate checking, or enforcement, can be applied to other wireless parking payment systems, using other methods of identifying a vehicle's parked locations. In such cases, the indicated vehicle locations can be less precise than in the system described here, such as covering an entire city block. Nevertheless, the systems/methods taught here could still benefit such systems and lead to a reduction of enforcement effort.

An example of performing parking session validation is provided according to this disclosure. All vehicles participating in the present system are preferably equipped with a short range wireless transponder, or tag, with a range such as 10 m, similar to RFID devices used for highway toll collection. The parking authority checking terminal is equipped with an RF interrogator that can communicate with the tags. According to methods of RF transponder interrogation known in the art, the interrogator issues a series of interrogations, or queries, as it drives slowly past the targeted parked vehicles. The time-rate at which the queries are issued can be controlled by the parking authority checker and will depend on the speed of the drive-by vehicle. The tags in the vehicle respond to the queries according to the rules of a chosen protocol, such as one which has the ability to resolve potentially colliding responses from a multiplicity of tags.

The responses from the tags include the vehicle IDs. These responded IDs are compared by the software in the parking authority checking terminal for matches with the downloaded IDs of subscriber vehicles located at that targeted area. It is expected that not all expected-expired vehicles are physically present. Therefore, the vehicles (physically present at the targeted location) which can be ticketed are either those with expired status or are a subset of vehicles with expected-expired status. Based on these matches, and assisted by the attributes of the vehicles, such as license plate number and image displayed on the parking authority checking terminal, the parking authority checker identifies the physical vehicles for enforcement.

In accordance with this disclosure, the parking location can be automatically sensed by a wireless communication device, or equivalent functionality built into a vehicle, using a positioning technology such as the Global Positioning System (GPS). This parking location can be augmented by other technologies, such as known locations of WiFi access point, locations of cellular base stations and, in the case where the parking application is built into the electronic system of the vehicle, on-board motion sensors, like inertial navigation systems.

With a wireless communication device, as opposed to similar electronics built into the car, it is clear that the wireless communication device can be used with different vehicles at different times. In prior art systems, such as Parkmobile, the user is required to enter the license plate number of the vehicle that is to be associated with a given wireless communication device, whose ID is known to the parking application server (shortcuts such as defaulting to the last used vehicle or selecting one of a list of stored vehicle IDs are also supported). In an embodiment of this disclosure, the vehicle associated with a wireless communication device can be determined automatically by enabling the wireless communication device to sense the vehicle's ID by means of a sensor located in/on the vehicle and causing this sensing action to trigger a software application (App) in the wireless communication device. The App reads the vehicle ID and stores it in the memory of the wireless communication device. The stored vehicle ID is used in parking applications executed on the wireless communication device and remains the default vehicle ID until and unless it is overwritten by another act of sensor scanning.

Various methods of vehicle ID sensing are possible, including but not limited to the following: optical scanning of a bar code, including QR code; RFID interrogation of an RFID tag located in/on the vehicle; Bluetooth transaction performed with a Bluetooth device located in/on the vehicle, the Bluetooth device ID being associated with the vehicle ID.

An embodiment relates to a system of payment for parking of a vehicle including a wireless communication device including a positioning device configured to determine a location of the wireless communication device, a transceiver configured to communicate with a parking authority server, a processor operably connected to the positioning device and the transceiver. The processor is configured to determine the location of the wireless device, initiate a parking session with the parking authority server and transmit the location of the wireless communication device and an ID of the vehicle or the user to the parking authority server, and allow a user to change the street parking location with the wireless communication device.

Another embodiment relates to a method of payment of parking of a vehicle including determining the location of the vehicle with a wireless communication device, initiating a parking session with the parking authority server, transmitting the location of the wireless communication device and an ID of the vehicle or the user to the parking authority server, and allow a user to change the street parking location with the wireless communication device.

Another embodiment relates to a system to determine the identity of a vehicle in which a wireless communication device is located, including an identification device in the vehicle that can be sensed by a sensor in the wireless communication device. The wireless communication device includes a transceiver configured to communicate with a server and a processor. The processor is configured to sense an identity of the vehicle from the identification device and communicate the identity to the server.

Another embodiment relates to a method of determining the identity of a vehicle in which a wireless communication device is located including sensing an identity of the vehicle from an identification device in the vehicle with the wireless communication device and communicating the identity to a server.

Another embodiment relates to a system of payment for parking in open streets using one or more functional subsystems built into the electronic system of a vehicle including a wireless data modem configured to communicate with a server, a parking application software loaded into an electronic system of the vehicle, a positioning subsystem configured to use a satellite navigation technology and an inertial navigation technology. The positioning subsystem can automatically sense the vehicle's location and the parking application is configured to send a location and a vehicle identification and or user identification to the server as inputs for starting a parking session.

Another embodiment relates to a method of payment for parking in open streets using one or more functional subsystems built into the electronic system of a vehicle including automatically sensing the vehicle's location with a positioning subsystem configured to use a satellite navigation technology and an inertial navigation technology and sending the location and a vehicle identification and or user identification to a server with a wireless data modem as inputs for starting a parking session.

This disclosure also provides for user correction of an indicated position. In an embodiment of user provided correction, a GPS indicates an estimated position on an electronic map, which position can be corrected by the user based on an awareness of his or her whereabouts. As in prior art navigation systems, currently available in wireless communication devices and vehicles, the user can be aided by the map displaying prominent landmarks and street names. The user can correct the user platform indicated position by selecting a position on the displayed map different from the indicated position. The inputting of an alternate position can be performed by the user touching a touch sensitive display screen, using technologies well known in the prior art.

In another embodiment, parking location status (e.g., parking spot available or not available) can be identified through the parking App. With appropriate sensors located in parking areas, there is no need for human verification (e.g., parking checkers, meter maids, and the like) of a parking spot being used. In this embodiment, a parking authority can do advanced usage studies to understand demand and utilization and optimize parking accordingly. Likewise, any parking spot owners can manage inventory and track usage and payment. Through use of the sensors, available parking spaces can be identified by consumers through the App. The App can show all parking spaces being offered and which are available and not available for parking.

The steps and/or actions of a method described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to the processor, such that the processor can read information from, and write information to, the storage medium. In the alternative, the storage medium can be integral to the processor. Further, in some embodiments, the processor and the storage medium can reside in an Application Specific Integrated Circuit (ASIC). In the alternative, the processor and the storage medium can reside as discrete components in a computing device. Additionally, in some embodiments, the events and/or actions of a method can reside as one or any combination or set of codes and/or instructions on a machine-readable medium and/or computer-readable medium, which can be incorporated into a computer program product.

In one or more embodiments, the functions described can be implemented in hardware, software, firmware, or any combination thereof. If implemented in software, the functions can be stored or transmitted as one or more instructions or code on a computer-readable medium. Computer-readable media includes both computer storage media and communication media including any medium that facilitates transfer of a computer program from one place to another. A storage medium can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection can be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above are included within the scope of computer-readable media.

Computer program code for carrying out operations of embodiments of the present disclosure can be written in an object oriented, scripted or unscripted programming language such as Java, Perl, Smalltalk, C++, or the like. However, the computer program code for carrying out operations of embodiments of the present disclosure can also be written in conventional procedural programming languages, such as the “C” programming language or similar programming languages.

Embodiments of the present disclosure are described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer readable memory produce an article of manufacture including instruction means that implement the function/act specified in the flowchart and/or block diagram block(s).

The computer program instructions can also be loaded onto a computer or other programmable data processing apparatus to cause a series of operational steps to be performed on the computer or other programmable apparatus to produce a computer-implemented process so that the instructions which execute on the computer or other programmable apparatus provide steps for implementing the functions/acts specified in the flowchart and/or block diagram block(s). Alternatively, computer program implemented steps or acts can be combined with operator or human implemented steps or acts in order to carry out an embodiment of the present disclosure.

It will be understood that the present disclosure can be embodied in a computer readable non-transitory storage medium storing instructions of a computer program which when executed by a computer system results in performance of steps of the method described herein. Such storage media can include any of those mentioned in the description above.

Where methods described above indicate certain events occurring in certain orders, the ordering of certain events can be modified. Moreover, while a process depicted as a flowchart, block diagram, and the like can describe the operations of the system in a sequential manner, it should be understood that many of the system's operations can occur concurrently or in a different order.

The terms “comprises” or “comprising” are to be interpreted as specifying the presence of the stated features, integers, steps or components, but not precluding the presence of one or more other features, integers, steps or components or groups thereof.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it can be based on one or more other things as well. In other words, unless expressly indicated otherwise, as used herein “based on” means “based at least in part on” or “based at least partially on.”

The techniques described herein are exemplary, and should not be construed as implying any particular limitation on the present disclosure. It should be understood that various alternatives, combinations and modifications could be devised by those skilled in the art from the present disclosure. For example, steps associated with the processes described herein can be performed in any order, unless otherwise specified or dictated by the steps themselves. The present disclosure is intended to embrace all such alternatives, modifications and variances that fall within the scope of the appended claims.

What is claimed is:

1. A method comprising:
determining the location of the vehicle with a wireless communication device having a parking software application (App), wherein determining the location comprises using a positioning system;
transmitting the street parking location, a vehicle identification or user identification, and a payment to a parking authority server for initiating a street parking session, with the wireless communication device via the App; and
allowing a user to change the street parking location with the wireless communication device.

2. The method of claim 1, wherein allowing a user to change the street parking location comprises the user selecting another street parking location and initiating another street parking session with the wireless communication device.

3. The method of claim 1, wherein street parking comprises parking in any open area where there is no access barrier to available parking spots, and includes actual street parking and parking in open lots with no access control.

4. The method of claim 1, further comprising one or more of the following:
accessing rules and payment information for street parking of the vehicle at the location with the wireless communication device and the positioning system, receiving confirmation of payment from the parking authority server with the wireless communication device, receiving notification from the parking authority server of an end of the street parking session, and
receiving notification from the parking authority server of at least one of street parking session status including street parking session start and end times and street parking session remaining time.

5. The method of claim 1, wherein the positioning system is capable of combining satellite navigation and inertial navigation.

6. The method of claim 1, wherein the parking software application (App) is connected to the parking authority server, and wherein both the parking software application (App) and the parking authority server are configured to pay for street parking.

7. The method of claim 1, further comprising providing secure data links between the wireless communication device and the parking authority server.

8. The method of claim 1, further comprising:
identifying parked vehicles having an expired parking status comprising receiving information from the parking authority server and displaying the information on a portable checking terminal, wherein the information is associated with a plurality of parked vehicles and wherein the information comprises any of: approximate location of the parked vehicles on a geographic map; parking session start and end or expected end times; parking session status: expired; parking session status: unexpired or parking session status: expected-expired; and vehicle attributes selected from electronic identity, license plate number, make/model/color and vehicle image.

9. The method of claim 8, wherein the parked vehicles have in or on them at least one wireless identification tag and the portable checking terminal is configured to wirelessly interrogate the identification tag to identify parked vehicles with expired parking sessions.

10. The method of claim 9, wherein the identification of vehicles with expired and/or expected-expired parking sessions further comprises using the portable checking terminal to compare actual identification responses from the parked vehicles with the information received from the parking authority server regarding vehicles with expected-expired parking status; and determining which of the vehicles with expected-expired parking status are still physically parked in the approximate locations covered by the wireless interrogation.

11. A method comprising:
providing a wireless communication device having a parking software application (App);
determining the location of the vehicle with the wireless communication device, wherein determining the location comprises using a positioning system;
accessing rules and payment information for street parking of the vehicle at the location with the wireless communication device and the positioning system;
wirelessly transmitting the street parking location, a vehicle identification or user identification, and a payment to a parking authority server for initiating a street parking session, with the wireless communication device via the App;
receiving confirmation of payment from the parking authority server with the wireless communication device; and
allowing a user to change the street parking location with the wireless communication device.

12. The method of claim 11, wherein allowing a user to change the street parking location comprises the user selecting another street parking location and initiating another street parking session with the wireless communication device.

13. A system comprising:
a wireless communication device having a parking software application (App), said wireless communication device providing user input and output and position location capability, and
a parking authority server connected to the wireless communication device, wherein both the wireless communication device and the parking authority server are configured to pay for street parking according to a method comprising:
determining the location of a vehicle with a wireless communication device having a parking software application (App), wherein determining the location comprises using a positioning system;
transmitting the street parking location, a vehicle identification or user identification, and a payment to a parking authority server for initiating a street parking session, with the wireless communication device via the App; and
allowing a user to change the street parking location with the wireless communication device.

14. The system of claim 13, wherein street parking comprises parking in any open area where there is no access barrier to available parking spots, and includes actual street parking and parking in open lots with no access control.

15. The system of claim 13, which is configured to do one or more of the following: access rules and payment information for street parking of the vehicle at the location with the wireless communication device and the positioning system, receive confirmation of payment from the parking authority server with the wireless communication device, receive notification from the parking authority server of an end of the street parking session, receive notification from the parking authority server of at least one of street parking session status including street parking session start and end times and street parking session remaining time, and provide secure data links between the wireless communication device and the parking authority server.

16. The system of claim 13, wherein the positioning system is capable of combining satellite navigation and inertial navigation.

17. The system of claim 13, wherein the parking software application (App) is connected to the parking authority server, and wherein both the parking software application (App) and the parking authority server are configured to pay for street parking.

18. The system of claim 13, which is configured to identify parked vehicles having an expired parking status comprising receiving information from the parking authority server and displaying the information on a portable checking terminal, wherein the information is associated with a plurality of parked vehicles and wherein the information comprises any of: approximate location of the parked vehicles on a geographic map; parking session start and end or expected end times; parking session status: expired; parking session status: unexpired or parking session status: expected-expired; and vehicle attributes selected from electronic identity, license plate number, make/model/color and vehicle image.

19. The system of claim 18, wherein the parked vehicles have in or on them at least one wireless identification tag and the portable checking terminal is configured to wirelessly interrogate the identification tag to identify parked vehicles with expired parking sessions.

20. The system of claim 19, wherein the identification of vehicles with expired and/or expected-expired parking sessions further comprises using the portable checking terminal to compare actual identification responses from the parked vehicles with the information received from the parking authority server regarding vehicles with expected-expired parking status; and determining which of the vehicles with expected-expired parking status are still physically parked in the approximate locations covered by the wireless interrogation.

21. A system comprising:
a wireless communication device having a parking software application (App), said wireless communication device providing user input and output and position location capability, and
a parking authority server connected to the wireless communication device, wherein both the wireless communication device and the parking authority server are configured to pay for street parking according to a method comprising:
providing a wireless communication device having a parking software application (App);
determining the location of a vehicle with the wireless communication device, wherein determining the location comprises using a positioning system;
accessing rules and payment information for street parking of the vehicle at the location with the wireless communication device and the positioning system;
wirelessly transmitting the street parking location, a vehicle identification or user identification, and a payment to a parking authority server for initiating a street parking session, with the wireless communication device via the App;
receiving confirmation of payment from the parking authority server with the wireless communication device; and
allowing a user to change the street parking location with the wireless communication device.

22. A system comprising a wireless communications device which includes a user input and output and position location capability, and a server connected to the wireless communications device, wherein both the wireless communications device and the server are configured to pay for parking according to the method of claim 1.

23. A system comprising a vehicle electronic system which includes a user input and output, a wireless communications device and position location capable of combining satellite navigation and inertial navigation; a server connected to the wireless communications device; wherein both the vehicle electronic system and the server are configured to pay for parking according to the method of claim 1.
